(19) United States
(12) Patent Application Publication
(10) Pub. No.: US 2017/0361653 A1
(43) Pub. Date: Dec. 21, 2017

(54) TIRE COMPONENT

(71) Applicants: Xavier SAINTIGNY, Greenville, SC (US); Compagnie Generale des Etablissements Michelin, Clermont-Ferrand (FR)

(72) Inventor: Xavier SAINTIGNY, Greenville, SC (US)

(21) Appl. No.: 15/541,121

(22) PCT Filed: Dec. 28, 2015
(86) PCT No.: PCT/US2015/067574

§ 371 Date: Jun. 30, 2017

Related U.S. Application Data
(60) Provisional application No. 62/098,928, filed on Dec. 31, 2014.

(51) Int. Cl. B60C 1/00; C08L 9/06; C08K 3/04; C08K 3/06

(52) U.S. Cl. CPC B60C 1/0016; C08L 9/06; C08K 3/04; C08J 2323/22; C08K 3/06

(57) ABSTRACT

A tire component is disclosed that is made of a thermoplastic composition that is based upon a cross-linkable composition. The composition includes, per 100 parts by weight of the thermoplastic elastomer, 100 phr of a thermoplastic elastomer, wherein the thermoplastic elastomer is a block copolymer that comprises an elastomer block and a hard thermoplastic block. The elastomer block is a diene elastomer and the hard thermoplastic block has a glass transition temperature greater than 80° C. The composition further includes a reinforcing filler and a curing system. In particular embodiments the reinforcing filler may be carbon black, silica or combinations thereof.

This application claims the benefit of US provisional application 62/098928 filed Dec. 31, 2014 and is hereby incorporated herein by reference.

### BACKGROUND OF THE INVENTION

### Field of the Invention

This invention relates generally tire components and more particularly to the elastomer compositions used to manufacture them.

### DETAILED DESCRIPTION OF PARTICULAR EMBODIMENTS

Particular embodiments of the present invention include tire components, including treads, that comprises a thermoplastic elastomer that is a block copolymer. The tire components further include a reinforcing filler and a vulcanization system. These tire components demonstrate improved resistance to tear over commonly used rubber compositions that include, for example styrene-butadiene rubber as the elastomeric component. While the conventional tire is typically based almost entirely on diene elastomers, tire designers seek other materials for particular tire components that will provide improved properties.

Tire designers often think of thermoplastic elastomers as being “self-reinforced” and therefore do not see that a benefit that can be achieved by adding reinforcement fillers to them in the same manner as reinforcement fillers are added to diene rubber compositions. The compositions disclosed herein include thermoplastic elastomers having improved properties that were obtained by adding a reinforcement filler and a cure system.

As used herein, “phr” is “parts per hundred parts of rubber by weight” and is a common measurement in the art wherein components of a rubber composition are measured relative to the total weight of rubber in the composition, i.e., parts by weight of the component per 100 parts by weight of the total rubber(s) in the composition.

As used herein, rubber and elastomer are synonymous terms.

As used herein, “based upon” is a term recognizing that embodiments of the present invention are made of vulcanized or cured thermoplastic elastomer compositions that were, at the time of their assembly, uncured. The cured thermoplastic elastomer composition is therefore “based upon” the uncured thermoplastic elastomer composition. In other words, the cross-linked thermoplastic elastomer composition is based upon or comprises the constituents of the cross-linkable thermoplastic elastomer composition.

Thermoplastic elastomers (abbreviated to “TPEs”) have a structure intermediate between thermoplastic polymers and elastomers. They are block copolymers composed of hard thermoplastic blocks connected via flexible elastomer blocks. Such thermoplastic elastomer block copolymers are well known in the industry and have a wide range of structure and properties.

Particular embodiments of the thermoplastic compositions disclosed herein include a thermoplastic elastomer having a number-average molecular weight (denoted Mn) of between 30 000 and 500 000 g/mol, or alternatively between 40 000 and 400 000 g/mol.

Block copolymer thermoplastic elastomers are known to exhibit two glass transition temperatures (Tg) due to its construction of the elastomer blocks separated by the hard thermoplastic blocks. The elastomer block exhibits a glass transition temperature that is very low while the hard thermoplastic blocks have a Tg that is well above ambient. For particular embodiments disclosed herein, the hard thermoplastic block has a Tg that is greater than 80° C. or alternatively between 80° C. and 200° C. or between 90° C. and 175° C. Likewise the elastomer blocks may have, for particular embodiments, a Tg that is between −100° C. and 10° C. or alternatively between −95° C. and −10° C. The Tg' s may be determined by differential scanning calorimetry (DSC) in accordance with ASTM D3418.

The useful block copolymers include diblock copolymers and triblock copolymers. Diblock copolymers comprise a hard thermoplastic block and an elastomer block and triblock copolymers comprise two hard thermoplastic blocks connected by an elastomer block. The rigid and flexible segments can be positioned linearly, or in a star or branched configuration. Typically, for example, each of these segments or blocks often comprise a minimum of more than 5, generally of more than 10, base units (for example, styrene units and butadiene units for a styrene/butadiene/styrene block copolymer).

The elastomer blocks of the useful thermoplastic elastomer compositions are selected from diene elastomers. Diene elastomers are those that are derived at least in part (i.e., a homopolymer or a copolymer) from diene monomers, which are those having two (conjugated or not) carbon-carbon double bonds.

Diene elastomers may be classified as “essentially unsaturated” and “essentially saturated.” Generally the expression “essentially unsaturated diene elastomers” are understood herein to mean a diene elastomer resulting at least in part from conjugated diene monomers having a number of diene units or units of diene origin (conjugated dienes) that is greater than 15 mol %. Thus, for example, diene elastomers such as butyl rubbers or diene/α-olefin copolymers of the EPDM type do not fall within the above definition and may be termed essentially saturated diene elastomers.

Within the essentially unsaturated diene elastomer category are included the “highly unsaturated diene elastomers,” which are those elastomers having a number of units of diene origin (conjugated dienes) that is greater than 50 mol %.

For particular embodiments of the compositions disclosed herein, the elastomer block is selected from highly unsaturated diene elastomers, examples of which are those that result from isoprene, butadiene or combinations thereof.

The hard thermoplastic blocks can be polymerized from a variety of monomers. In particular embodiments of the compositions disclosed herein, the hard thermoplastic blocks can be formed, for example, from the following and mixtures thereof: polyolefins, polyurethanes, polyamides and polystyrenes. In particular, the polystyrenes are obtained from styrene monomers. The term “styrene monomer” is understood to mean herein any monomer based on styrene, unsubstituted and substituted, including for example the substituted styrenes of methylstyrenes (for example, o-methylstyrene, m-methylstyrene or p-methylstyrene, α-methylstyrene, α,2-dimethylstyrene, α,4-dimethylstyrene or diphenyl-ethylene), para-(tert-butyl)styrene, chloro-styrenes (for example, o-chlorostyrene, m-chlorostyrene, p-chlorostyrene, 2,4-dichlorostyrene, 2,6-dichlorostyrene or 2,4,6-trichlorostyrene), bromostyrenes (for example, o-bromostyrene, m-bromostyrene, p-bromostyrene, 2,4-dibromostyrene, 2,6-dibromostyrene or 2,4,6-tribromostyrene), fluorostyrenes (for example, o-fluorostyrene, m-fluorostyrene, p-fluorostyrene, 2,4-difluorostyrene, 2,6-difluorostyrene or 2,4,6-trifluorostyrene) or also para-hydroxystyrene.

For particular embodiments of the disclosed compositions, the hard thermoplastic blocks are polystyrenes and the content by weight of the styrene in the thermoplastic elastomer is between 5 wt % and 50 wt %. Below the minimum level of styrene blocks, the thermoplastic nature of the elastomer is substantially reduced while at the higher level the desired physical properties of the elastomer and the tire components are affected. Alternatively the styrene content is between 10 wt % and 40 wt %.

Examples of suitable thermoplastic elastomers include those wherein the elastomer part is unsaturated, the blocks comprising styrene blocks as the hard thermoplastic blocks and diene blocks as the elastomer blocks, these diene blocks being in particular isoprene or butadiene blocks. Such thermoplastic elastomers may be selected from diblock or triblock copolymers that are linear or star-branched: linear or star-branched styrene/butadiene (SB), linear or star-branched styrene/isoprene (SI), linear or star-branched styrene/butadiene/isoprene (SBI), styrene/butadiene/styrene (SBS), styrene/isoprene/styrene (SIS), styrene/butadiene/isoprene/styrene (SBIS) and the mixtures of these copolymers.

Suitable thermoplastic elastomers are readily available, examples of which are those supplied by Kraton Performance Polymers, Inc. with offices in Houston, Tex. Examples include Kraton D-1192 SBS block copolymer having a styrene content of 30 wt % and D-1165 SIS block copolymer having a styrene content of 30 wt %.

In addition to the thermoplastic elastomers disclosed above, the useful thermoplastic elastomer compositions further include a reinforcing filler. While particular embodiments may include any type of filler generally used in tires, including carbon black and reinforcing inorganic fillers such as silica, other embodiments are limited only to carbon black as a reinforcing filler.

All the carbon blacks typically used in tires (tire-grade blacks) are useful as the reinforcing filler for particular embodiments of the disclosed compositions. Examples include the reinforcing blacks of the 100, 200 or 300 series (ASTM grades) such as the N115, N134, N234, N326, N330, N339, N347 or N375 black. Also suitable, depending on the particular application, the higher series blacks may be used, such as N660, N683, N772 or N990.

The term “reinforcing inorganic filler” is defined as any inorganic or mineral filler, whatever its color and its origin (natural or synthetic), capable of reinforcing by itself alone, without means other than an intermediate coupling agent, a rubber or elastomer composition intended for the manufacture of tires. Such may also be known as “white filler”, “clear filler” or indeed even “non-black filler”, in contrast to carbon black. Such fillers are generally characterized by having hydroxyl (—OH) groups at its surface.

Such inorganic fillers may be used in any form, whether it is in the form of a powder, of microbeads, of granules, of beads or any other appropriate form. Of course the term “reinforcing inorganic filler” is also understood to mean mixtures of different reinforcing inorganic fillers, in particular of highly dispersible siliceous and/or aluminous fillers as described below.

Mineral fillers of the siliceous type, in particular silica (SiO₂), or of the aluminous type, in particular alumina (Al₂O₃), are suitable in particular as reinforcing inorganic fillers. The silica used can be any reinforcing silica known to a person skilled in the art, in particular any precipitated or fumed silica exhibiting a BET specific surface and a CTAB specific surface both of less than 450 m²/g or alternatively between 30 m²/g and 400 m²/g. Examples include, as highly dispersible precipitated silicas (HDSs), the Ultrasil 7000 and Ultrasil 7005 silicas from Degussa, the Zeosil 1165 MP, 1135 MP and 1115 MP silicas from Rhodia, the Hi-Sil EZ150G silica from PPG, the Zeopol 8715, 8745 and 8755 silicas from Huber.

When using a reinforcing inorganic filler, a coupling agent is typically provided to couple the inorganic filler to the elastomer. Known coupling agents include at least bifunctional coupling agent (or bonding agent) intended to provide a satisfactory connection, of chemical and/or physical nature, between the inorganic filler (surface of its particles) and the elastomer, in particular bifunctional organosilanes or polyorganosiloxanes.

The amount of the reinforcing filler useful in particular embodiments of the present invention is between 5 phr and 40 phr or alternatively between 10 phr and 30 phr. As noted, the reinforcing filler may be carbon black, inorganic filler or combinations thereof. In particular embodiments, the filler is limited to carbon black. Lesser amounts than the indicated minima or greater amounts than the indicated maxima do not provide the levels of improvement in the physical properties that are obtained within the indicated ranges.

In addition to the thermoplastic elastomer and the reinforcing filler, particular embodiments may also optionally include a plasticizer. Plasticizers are well known to those skilled in the art and include plasticizing resins, plasticizing oils and combinations thereof. The plasticizers facilitate the processing of the thermoplastic elastomer composition but may also provide improved physical properties to the cured product.

Suitable plasticizing liquids may include any liquid known for its plasticizing properties with diene elastomers. At room temperature (23° C.), these liquid plasticizers or these oils of varying viscosity are liquid as opposed to the resins that are solid. Examples include those derived from petroleum stocks, those having a vegetable base and combinations thereof. Examples of oils that are petroleum based include aromatic oils, paraffinic oils, naphthenic oils, MES oils, TDAE oils and so forth as known in the industry. Also known are liquid diene polymers, the polyolefin oils, ether plasticizers, ester plasticizers, phosphate plasticizers, sulfonate plasticizers and combinations of liquid plasticizers.

Examples of suitable vegetable oils include sunflower oil, soybean oil, safflower oil, corn oil, linseed oil and cotton seed oil. These oils and other such vegetable oils may be used singularly or in combination. In some embodiments, sunflower oil having a high oleic acid content (at least 70 weight percent or alternatively, at least 80 weight percent) is useful, an example being AGRI-PURE 80, available from Cargill with offices in Minneapolis, Minn. In particular embodiments of the present invention, the selection of a suitable plasticizing liquid is limited to a vegetable oil having a high oleic acid content.

A plasticizing hydrocarbon resin is a hydrocarbon compound that is solid at ambient temperature (e.g., 23° C.) as opposed to a liquid plasticizing compound, such as a plasticizing oil and is added in quantities that allows the resin to act as a true plasticizing agent, e.g., at a concentration that is typically at least 5 phr (parts per hundred parts rubber by weight).

Plasticizing hydrocarbon resins are polymers that can be aliphatic, aromatic or combinations of these types, meaning that the polymeric base of the resin may be formed from aliphatic and/or aromatic monomers. These resins can be natural or synthetic materials and can be petroleum based, in which case the resins may be called petroleum plasticizing resins, or based on plant materials. Such resins are well known and include, for example, terpene resins, C₅-C₉ resins, homopolymers or copolymers of cyclopentadiene or dicyclopentadiene. In particular embodiments, such resins are limited to those having a Tg of at least 25° C. (in accordance with ASTM D3418) or alternatively between 25° C. and 95° C., between 40° C. and 85° C. or between 60° C. and 80° C.

The amount of plasticizing resin and/or oil to include in any particular embodiment is dependent upon the particular circumstances and the desire result and well within the knowledge of one having ordinary skill in the art based, for example, on the ease of processing the thermoplastic elastomer composition and the desired physical characteristics of the cured composition, such as modulus. Typically such plasticizers may be added in amounts of between 0 phr and 80 phr or alternatively between 0 phr and 50 phr or between 5 phr and 50 phr.

In addition to the thermoplastic elastomers, the reinforcing fillers and the plasticizers described above, particular embodiments of the present invention further include any suitable curing system including a peroxide curing system or a sulfur curing system. Particular embodiments are cured with a sulfur curing system that includes free sulfur and may further include, for example, one or more of accelerators, stearic acid and zinc oxide. Suitable free sulfur includes, for example, pulverized sulfur, rubber maker's sulfur, commercial sulfur, and insoluble sulfur. The amount of free sulfur included in the TPE composition is not limited and may range, for example, between 0.5 phr and 10 phr or alternatively between 0.5 phr and 5 phr or between 0.5 phr and 3 phr. Particular embodiments may include no free sulfur added in the curing system but instead include sulfur donors.

Accelerators are used to control the time and/or temperature required for vulcanization and to improve the properties of the cured TPE composition. Particular embodiments of the present invention include one or more accelerators. One example of a suitable primary accelerator useful in the present invention is a sulfenamide. Examples of suitable sulfenamide accelerators include n-cyclohexyl -2-benzothiazole sulfenamide (CBS), N-tert-butyl-2-benzothiazole Sulfenamide (TBBS), N-Oxydiethyl-2-benzthiazolsulfenamid (MBS) and N′-dicyclohexyl-2-benzothiazolesulfenamide (DCBS). Combinations of accelerators are often useful to improve the properties of the cured TPE composition and the particular embodiments include the addition of secondary accelerators.

Particular embodiments may include as a secondary accelerant the use of a moderately fast accelerator such as, for example, diphenylguanidine (DPG), triphenyl guanidine (TPG), diorthotolyl guanidine (DOTG), o-tolylbigaunide (OTBG) or hexamethylene tetramine (HMTA). Such accelerators may be added in an amount of up to 4 phr, between 0.5 and 3 phr, between 0.5 and 2.5 phr or between 1 and 2 phr. Particular embodiments may exclude the use of fast accelerators and/or ultra-fast accelerators such as, for example, the fast accelerators: disulfides and benzothiazoles; and the ultra-accelerators: thiurams, xanthates, dithiocarbamates and dithiophosphates.

Other additives can be added to the TPE compositions disclosed herein as known in the art. Such additives may include, for example, some or all of the following: antidegradants, antioxidants, fatty acids, waxes, stearic acid and zinc oxide. Examples of antidegradants and antioxidants include 6PPD, 77PD, IPPD and TMQ and may be added to TPE compositions in an amount, for example, of from 0.5 phr and 5 phr. Zinc oxide may be added in an amount, for example, of between 1 phr and 6 phr or alternatively, of between 1.5 phr and 4 phr. Waxes may be added in an amount, for example, of between 1 phr and 5 phr.

The TPE compositions that are embodiments of the present invention may be produced in suitable mixers, in a manner known to those having ordinary skill in the art, typically using two successive preparation phases, a first phase of thermo-mechanical working at high temperature, followed by a second phase of mechanical working at lower temperature.

The first phase of thermo-mechanical working (sometimes referred to as “non-productive” phase) is intended to mix thoroughly, by kneading, the various ingredients of the composition, with the exception of the vulcanization system. It is carried out in a suitable kneading device, such as an internal mixer or an extruder, until, under the action of the mechanical working and the high shearing imposed on the mixture, a maximum temperature generally between 120° C. and 190° C., more narrowly between 130° C. and 170° C., is reached.

After cooling of the mixture, a second phase of mechanical working is implemented at a lower temperature. Sometimes referred to as “productive” phase, this finishing phase consists of incorporating by mixing the vulcanization (or cross-linking) system (sulfur or other vulcanizing agent and accelerator(s)), in a suitable device, for example an open mill. It is performed for an appropriate time (typically between 1 and 30 minutes, for example between 2 and 10 minutes) and at a sufficiently low temperature lower than the vulcanization temperature of the mixture, so as to protect against premature vulcanization.

The TPE composition can be formed into useful articles, including treads for use on vehicle tires. The treads may be formed as tread bands and then later made a part of a tire or they be formed directly onto a tire carcass by, for example, extrusion and then cured in a mold. As such, tread bands may be cured before being disposed on a tire carcass or they may be cured after being disposed on the tire carcass. Typically a tire tread is cured in a known manner in a mold that molds the tread elements into the tread, including, e.g., the sipes molded into the tread blocks.

The invention is further illustrated by the following examples, which are to be regarded only as illustrations and not delimitative of the invention in any way.

### EXAMPLE 1

Thermoplastic elastomer compositions were prepared using the components shown in Table 1. The amount of each component making up the thermoplastic elastomer compositions shown in Table 1 are provided in parts per hundred parts of thermoplastic elastomer by weight (phr).

TABLE 1
Formulations

| | Formulation Group | | |
|---|---|---|---|
| | FG1 | FG2 | FG3 |
| TPE D-1102 | 100 | | |
| TPE D-1192 | | 100 | |
| TPE D-1165 | | | 100 |
| N234 | 0-90 | 0-90 | 0-90 |
| Resin | 0 | 0 | 0 |
| Oil | 0 | 0 | 0 |
| Wax | 2 | 2 | 2 |
| Stearic Acid | 1 | 1 | 1 |
| Zinc Oxide | 1 | 1 | 1 |
| CBS | 1 | 1 | 1 |
| Sulfur | 1 | 1 | 1 |

The thermoplastic resins were manufactured by Kraton Polymers. The Kraton thermoplastic resins were D-1102, an SBS linear triblock copolymer based on styrene and butadiene having a polystyrene content of 28%; D-1192, an SBS linear block copolymer based on styrene a butadiene with mound styrene of 30%; and D-1165, a linear triblock copolymer based on styrene and isoprene with a polystyrene content of 29%.

Each formulation group included thermoplastic elastomer compositions that were the same except for the amount of carbon black added. Each group included formulations that contained between 0 phr, 10 phr, 20 phr and so forth to 90 phr of carbon black. Therefore, for example, formulation FG1_{20CB} contained 20 phr of carbon black.

The formulations were prepared by mixing the components in a Banbury mixer having a jacket temperature of 80° C. and a rotor speed of 55 RPM. The elastomer was first added, then after the temperature reached around 60° C. the other components were added other than the sulfur. Mixing continued until a temperature of about 160° C. was reached, when the mixture was dropped and cooled. The sulfur was then added to the mixture on a mill.

Vulcanization was then effected as follows. For FG1, the formulations were vulcanized for 55 minutes at 150° C. For FG2, the formulations were vulcanized for 40 minutes at 150° C. For FG3, for formulations FG3_{0CB} through FG3_{40CB} the formulations were vulcanized for 30 minutes at 150° C.; for formulations FG3_{80CB} and FG3_{90CB} the formulations were vulcanized for 16 minutes at 150° C.; and for formulations FG3_{80CB} and FG3_{90CB} the formulations were vulcanized for 5 minutes at 150° C.

The elongation property was measured for the cured samples as elongation at break (%) and the corresponding elongation stress (MPa), which is measured at 23° C. based on ASTM Standard D412 on dumb bell test pieces. These results are shown in Table 2.

TABLE 2
Elongation Properties

| | 0 | 10 | 20 | 30 | 40 | 50 | 70 | 90 |
|---|---|---|---|---|---|---|---|---|
| | phr | phr | phr | phr | phr | phr | phr | phr |
| FG1 Elonga- | 266 | 327 | 511 | 377 | 333 | 261 | 161 | 88 |
| tion, % | | | | | | | | |
| FG1 Force, | 7.4 | 12.3 | 24.9 | 20.7 | 20.7 | 19.9 | 19.8 | 17.2 |
| MPa | | | | | | | | |
| FG2 Elonga- | 405 | 527 | 600 | 506 | 444 | 311 | 244 | 133.3 |
| tion, % | | | | | | | | |
| FG2 Force, | 10.3 | 18.6 | 26.2 | 23.2 | 20.7 | 18.8 | 18.5 | 17.8 |
| MPa | | | | | | | | |
| FG3 Elonga- | 618 | 792 | 778 | 618 | 541 | 347 | 298 | 250 |
| tion, % | | | | | | | | |
| FG3 Force, | 12.8 | 21.2 | 23.0 | 18.7 | 16.6 | 13.9 | 14.5 | 13.9 |
| MPa | | | | | | | | |

The terms “comprising,” “including,” and “having,” as used in the claims and specification herein, shall be considered as indicating an open group that may include other elements not specified. The term “consisting essentially of,” as used in the claims and specification herein, shall be considered as indicating a partially open group that may include other elements not specified, so long as those other elements do not materially alter the basic and novel characteristics of the claimed invention. The terms “a,” “an,” and the singular forms of words shall be taken to include the plural form of the same words, such that the terms mean that one or more of something is provided. The terms “at least one” and “one or more” are used interchangeably. The term “one” or “single” shall be used to indicate that one and only one of something is intended. Similarly, other specific integer values, such as “two,” are used when a specific number of things is intended. The terms “preferably,” “preferred,” “prefer,” “optionally,” “may,” and similar terms are used to indicate that an item, condition or step being referred to is an optional (not required) feature of the invention. Ranges that are described as being “between a and b” are inclusive of the values for “a” and “b.”

It should be understood from the foregoing description that various modifications and changes may be made to the embodiments of the present invention without departing from its true spirit. The foregoing description is provided for the purpose of illustration only and should not be construed in a limiting sense. Only the language of the following claims should limit the scope of this invention.

1. A tire comprising a tire component, the tire component comprising a thermoplastic composition that is based upon a cross-linkable composition comprising, per 100 parts by weight of the thermoplastic elastomer:
100 phr of a thermoplastic elastomer, wherein the thermoplastic elastomer is a block copolymer that comprises an elastomer block and a hard thermoplastic block, wherein the elastomer block is a diene elastomer and the hard thermoplastic block has a glass transition temperature greater than 80° C.;
between 5 phr and 40 phr of a reinforcing filler; and
a curing system.

2. The tire of claim 1, wherein the filler is selected from a carbon black, a silica or combinations thereof.

3. The tire of claim 1, wherein the filler is carbon black.

4. The tire of claim 1, wherein the elastomer block is a highly unsaturated diene elastomer.

5. The tire of claim 4, wherein the unsaturated diene elastomer is selected from those resulting from isoprene, butadiene or combinations thereof.

6. The tire of claim 1, wherein the hard thermoplastic block is selected from polystyrenes, polyamines, polyurethanes or combinations thereof.

7. The tire of claim 1, wherein the thermoplastic block copolymer is selected from styrene/butadiene (SB) thermoplastic elastomers, styrene/isoprene (SI) thermoplastic elastomers, styrene/butadiene/isoprene (SBI) thermoplastic elastomers, styrene/butadiene/styrene (SBS) thermoplastic elastomers, styrene/isoprene/styrene (SIS) thermoplastic elastomers, and styrene/butadiene/isoprene/styrene (SBIS) thermoplastic elastomers, and mixtures thereof.

8. The tire of claim 1, wherein the cross-linkable composition further comprises a plasticizer.

9. The tire of claim 8, wherein the plasticizer is selected from a plasticizing resin, a plasticizing oil or combinations thereof.

10. The tire of claim 1, wherein the tire component is a tread.

11. The tire of claim 1, wherein the reinforcing filler is between 10 phr and 30 phr.
